(19) United States
(12) Patent Application Publication
(10) Pub. No.: US 2026/0142099 A1
(43) Pub. Date: May 21, 2026

(54) KEYBOARD AND KEYSWITCH STRUCTURE THEREOF

(71) Applicant: Darfon Electronics Corp., Taoyuan City (TW)

(72) Inventors: Yu Chun HSIEH, Taoyuan City (TW); Chen YANG, Taoyuan City (TW); Chun Hua CHANG, Taoyuan City (TW)

(21) Appl. No.: 19/392,268

(22) Filed: Nov. 18, 2025

Related U.S. Application Data
(60) Provisional application No. 63/721,654, filed on Nov. 18, 2024.

(30) Foreign Application Priority Data
Oct. 16, 2025 (TW) 114140049

(51) Int. Cl. H01H 13/84; H01H 13/28; H01H 13/52; H01H 13/81

(52) U.S. Cl. CPC H01H 13/84; H01H 13/28; H01H 13/52; H01H 13/81; H01H 2013/525

(57) ABSTRACT

A keyboard includes a first keyswitch including a first shielding member and a first Hall sensor, a second keyswitch disposed adjacent to the first keyswitch and including a second shielding member and a second Hall sensor, and a magnet disposed between the first keyswitch and the second keyswitch and spaced apart from the first Hall sensor by a first fixed distance and the second Hall sensor by a second fixed distance. When the first keyswitch is pressed, the first shielding member moves relative the magnet and changes a magnetic field strength of the magnet sensed by the first Hall sensor; when the second keyswitch is pressed, the second shielding member moves relative to the magnet and changes a magnetic field strength of the magnet sensed by the second Hall sensor.

### CROSS-REFERENCE TO RELATED APPLICATION

This application claims the priority benefits of Taiwan patent application serial No. 114140049, field on October 16, 2025, and also claims the priority benefits of US provisional application serial No. 63/721,654, field on November 18, 2024. The entirety of the mentioned above patent applications is hereby incorporated by reference herein and made a part of this specification.

### BACKGROUND OF THE INVENTION

### 1. Field of the Invention

The invention generally relates to a keyboard. Particularly, the invention relates to a keyboard utilizing the Hall effect and a keyswitch structure thereof.

### 2. Description of the Related Art

A keyboard generally includes multiple keyswitches, and each keyswitch has a corresponding trigger switch. Taking a conventional magnetic keyboard as an example, each keyswitch requires a magnet and a corresponding Hall sensor as the trigger switch. Consequently, the entire keyboard usually requires several tens or even hundreds of magnets, resulting in high cost and relatively heavy weight of the keyboard.

### SUMMARY OF THE INVENTION

It is an object of the invention to provide a keyboard, which shields the magnetic field to change the magnetic field strength sensed by the Hall sensor, so that adjacent keyswitches can share a same magnet to effectively reduce the amount of magnets, thereby reducing the cost and weight of the keyboard.

In an embodiment, the invention provides a keyboard, which includes a first keyswitch, a second keyswitch, and a magnet, wherein the first keyswitch includes a first shielding member and a first Hall sensor; the second keyswitch is disposed adjacent to the first keyswitch; the second keyswitch includes a second shielding member and a second Hall sensor; the magnet is disposed between the first keyswitch and the second keyswitch; the magnet is spaced apart from the first Hall sensor by a first fixed distance, and the magnet is spaced apart from the second Hall sensor by a second fixed distance. When the first keyswitch is pressed, the first shielding member moves relative to the magnet and changes the magnetic field strength of the magnet sensed by the first Hall sensor; when the second keyswitch is pressed, the second shielding member moves relative to the magnet and changes the magnetic field strength of the magnet sensed by the second Hall sensor.

In an embodiment, the first fixed distance is substantially equal to the second fixed distance.

In an embodiment, the keyboard of the invention further includes a circuit board. The circuit board is disposed below the first keyswitch and the second keyswitch. The first Hall sensor and the second Hall sensor are electrically disposed on the circuit board.

In an embodiment, the keyboard of the invention further includes a positioning frame. The positioning frame is disposed above the circuit board. The first keyswitch and the second keyswitch are positioned by the positioning frame, and the magnet is disposed on the positioning frame or the circuit board.

In an embodiment, each of the first keyswitch and the second keyswitch further includes a restoring mechanism disposed on the circuit board. The restoring mechanism includes a casing, a plunger, and an elastic member. The plunger is movably coupled with the casing; the elastic member is disposed in the casing and moves along with the plunger, wherein one of the elastic member and the plunger serves as the first shielding member or the second shielding member.

In an embodiment, the circuit board has a first opening and a second opening. The first opening and the second opening are respectively disposed corresponding to the first shielding member and the second shielding member and allow the first shielding member to at least partially extend into the first opening when the first keyswitch is pressed and the second shielding member to at least partially extend into the second opening when the second keyswitch is pressed.

In an embodiment, the first keyswitch includes a first keycap and a first support mechanism. The first support mechanism is disposed under the first keycap and supports the first keycap to move relative to the circuit board. The first shielding member is disposed on the first support mechanism. The first support mechanism drives the first shielding member to move relative to the magnet.

In an embodiment, the second keyswitch includes a second keycap and a second support mechanism. The second support mechanism is disposed under the second keycap and supports the second keycap to move relative to the circuit board. The second shielding member is disposed on the second support mechanism. The second support mechanism drives the second shielding member to move relative to the magnet.

In an embodiment, the first keyswitch includes a first keycap. The second keyswitch includes a second keycap. The magnet is located outside vertical projections of the first keycap and the second keycap.

In an embodiment, the first shielding member and the second shielding member are symmetrically disposed with respect to the magnet.

In an embodiment, each of the first shielding member and the second shielding member includes a magnetically conductive material. The magnetically conductive material includes iron, cobalt, nickel, or an alloy thereof.

It is another object of the invention to provide a keyswitch structure, which utilizes the elastic member as a shielding member to enable the keyswitch structure to generate a trigger signal by the Hall effect.

In another embodiment, the invention provides a keyswitch structure, which includes a keycap, an elastic member, a Hall sensor, and a magnet, wherein the elastic member is disposed under the keycap to provide a restoring force; the Hall sensor is disposed below the elastic member; the magnet is disposed corresponding to the Hall sensor. When the keycap is pressed, the magnet and the Hall sensor are spaced apart by a fixed distance, and the elastic member moves relative to the magnet to change a magnetic field strength of the magnet sensed by the Hall sensor.

In an embodiment, the elastic member includes a magnetically conductive material. The magnetically conductive material includes iron, cobalt, nickel, or an alloy thereof.

Compared with the prior art, the keyboard of the invention changes the magnetic field strength sensed by the Hall sensor by shielding the magnetic field, so that adjacent keyswitches can share a same magnet to effectively reduce the amount of magnets and reduce the cost and weight of the keyboard. Moreover, the keyswitch structure of the invention utilizes the elastic member as a shielding member, so that the customized design of the shielding member can be simplified, enhancing the design freedom and the suitability for various keyswitch structures.

### BRIEF DESCRIPTION OF THE DRAWINGS

FIGS. 1 and 2 are a partially exploded view and a schematic top view of the keyboard in a first embodiment of the invention.

FIG. 3 is a cross-sectional view of FIG. 2 along the A-A line.

FIGS. 4A and 4B are operation views of adjacent keyswitches of FIG. 3.

FIG. 5 is a three-dimensional view of the keyboard in a second embodiment of the invention.

FIG. 6 is an exploded view of the keyswitch structure of the keyboard of FIG. 5.

FIG. 7 is a cross-sectional view of the keyboard of FIG. 5.

FIGS. 8A and 8B are operation views of adjacent keyswitches of FIG. 7.

### DETAILED DESCRIPTION OF THE PREFERRED EMBODIMENT

The invention provides a keyboard, which utilizes the shielding member to change the magnetic field between the magnet and the Hall sensor, so that a plurality of keyswitches can share a same magnet to enable each of the plurality of keyswitches to generate a trigger signal by the Hall effect. The keyboard of the invention can be an independent keyboard device or a keyboard module integrated in any suitable electronic devices, such as the keyboard in portable electronic devices or laptop computers, wherein the magnet is disposed among and shared by a plurality of keyswitches to reduce the usage amount of magnets and the weight of the keyboard. With reference to the figures, the structure and operation of the keyboard of the invention will be described in detail.

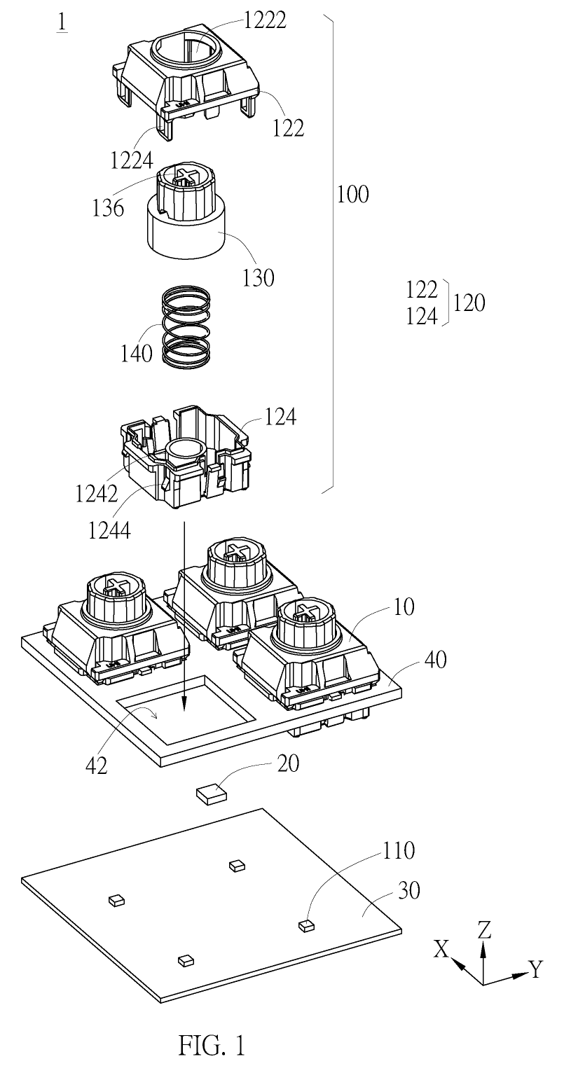

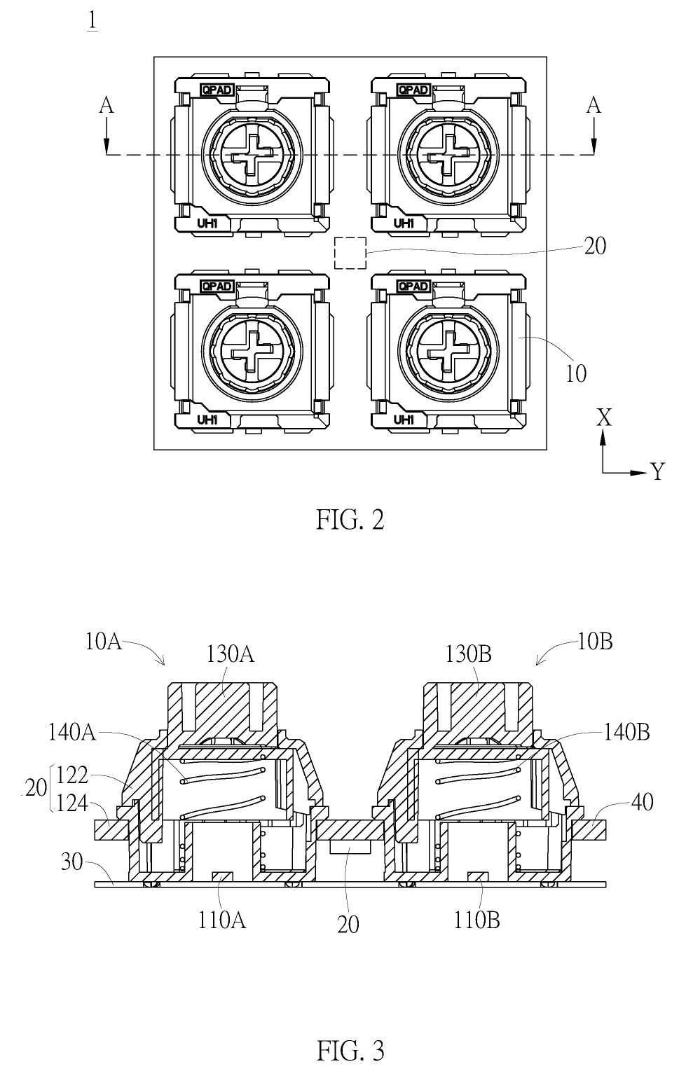

FIGS. 1 and 2 are a partially exploded view and a schematic top view of the keyboard 1 in a first embodiment of the invention. As shown in FIGS. 1 and 2, in an embodiment, the keyboard 1 of the invention includes a plurality of keyswitches 10 and a magnet 20. The magnet 20 is disposed among the plurality of keyswitches 10. The magnet 20 is shared by the plurality of keyswitches 10, so that each keyswitch 10 can use a same magnet 20 to constitute a trigger switch, which utilizes the Hall effect. It is noted that in this embodiment the keyboard 1 is illustrated with four keyswitches as an example, but not limited thereto. According to practical applications, the keyboard 1 may include two or more keyswitches. The keyswitches 10 preferably have a same structure, and each keyswitch 10 may include a Hall sensor 110 and a shielding member (e.g. 130 or 140), wherein the relative position of the Hall sensor 110 and the magnet 20 is fixed, and the shielding member is movably disposed in the keyswitch 10. Specifically, in the keyboard 1, the magnet 20 and the Hall sensor 110 of each keyswitch 10 are immovable components, and during the pressing of the keyswitch 10 the distance between the Hall sensor 110 of the pressed keyswitch 10 and the magnet 20 is unchanged.

Specifically, the magnet 20 can produce a magnetic field, and the Hall sensor 110 is a sensor that senses the existence and the strength of the magnetic field through the Hall effect. The output voltage of the Hall sensor 110 is proportional to the strength of the magnetic field. The fixed distance between the magnet 20 and the Hall sensor 110 can be defined as a predetermined distance that the Hall sensor 110 can output a predetermined voltage (e.g. first voltage) when the keyswitch 10 is in the non-pressed state. In other words, the fixed distance between the magnet 20 and the Hall sensor 110 can be any appropriate distance, which allows the Hall sensor 110 to sense the existence of the magnetic field of the magnet 20 and a certain degree of strength of the magnetic field of the magnet 20. The fixed distance can be determined according to the level of the magnet 20, the sensitivity of the Hall sensor 110, and the desired trigger distance.

In an embodiment, the fixed distance between the magnet 20 and the Hall sensor 110 of each keyswitch 10 is preferably the same. As such, when the keyswitches 10 are not pressed, the magnetic field strength of the magnet 20 sensed by the Hall sensor 110 of each of the keyswitches 10 is substantially the same, but not limited thereto. According to practical applications, when the fixed distances between the magnet 20 and the Hall sensors 110 of the plurality of keyswitches 10 are different, the output signal of each Hall sensor 110 can be calibrated by a processor so that each keyswitch 10 can generate the trigger signal when being pressed.

Moreover, in the keyboard 1, the shielding member of each keyswitch 10 is a movable component, which can move to a position capable of interfering with the magnetic field of the magnet 20 sensed by the Hall sensor 110 of the keyswitch 10 in response to the pressing operation of the keyswitch 10. From another aspect, in response to the pressing operation of the keyswitch, the shielding member will move to a region between the magnet 20 and the corresponding Hall sensor 110 to at least partially shield the magnetic field of the magnet 20, so that the magnetic field strength of the magnet 20 which is sensed by the Hall sensor 110 can be changed, and the keyswitch 10 is triggered to generate the trigger signal.

In an embodiment, the Hall sensors 110 of the plurality of keyswitches 10 are preferably symmetrically arranged with respect to the magnet 20. The shielding members of the plurality of keyswitches 10 are also preferably symmetrically arranged with respect to the magnet 20, and the vertical projection of each shielding member is preferably located between the magnet 20 and the corresponding Hall sensor 110. For example, when the magnet 20 is disposed among the plurality of keyswitches 10, the plurality of shielding members are preferably at least partially located on the vertical projection of the periphery of a first virtual circle, which has a center overlapping the magnet 20, and the plurality of Hall sensors are preferably located on the vertical projection of the periphery of a second virtual circle, which has a center overlapping the magnet 20, wherein the radius of the first virtual circle is smaller than the radius of the second virtual circle, but not limited thereto. In an embodiment, the plurality of shielding members are preferably evenly disposed on the vertical projection of the periphery of the first virtual circle. The plurality of Hall sensors are preferably evenly disposed on the vertical projection of the periphery of the second virtual circle. Each shielding member is preferably at least partially located on or in the neighborhood of the connecting line (e.g. radius line) between its corresponding Hall sensor and the magnet 20.

As shown in FIG. 1, the keyboard 1 further includes a circuit board 30. The circuit board 30 is disposed below the plurality of keyswitches 10, and the Hall sensor 110 of each keyswitch 10 is electrically disposed on the circuit board 30. For example, the Hall sensors 110 can be disposed on the upper surface of the circuit board 30 and electrically connected to the switch circuit of the circuit board 30, but not limited thereto. In another embodiment, the Hall sensors 110 can be disposed on the lower surface of the circuit board 30. In this embodiment, the keyboard 1 may further include a positioning frame 40. The positioning frame 40 is disposed above the circuit board 30, and the plurality of keyswitches 10 are positioned by the positioning frame 40. Specifically, the positioning frame 40 may be a frame with a plurality of openings 42. The plurality of openings 42 respectively correspond to the plurality of keyswitches 10. As such, the plurality of keyswitches 10 can be respectively disposed in the plurality of openings 42 of the positioning frame 40 to be supported and positioned by the positioning frame 40. For example, the positioning frame 40 can be an upper cover of the outer housing of the keyboard 1 or an independent support member within the keyboard 1.

In an embodiment, the magnet 20 can be disposed on the positioning frame 40 or the circuit board 30. For example, in the case that the positioning frame 40 is the upper cover of the outer housing of the keyboard 1, the magnet 20 is preferably disposed on the lower surface of the positioning frame 40, but not limited thereto. In the case that the positioning frame 40 is an independent support member within the keyboard 1, the magnet 20 can be disposed on the lower surface or the upper surface of the positioning frame 40. For example, the magnet 20 can be positioned on the positioning frame 40 or the circuit board 30 by adhesion, engagement, or any suitable positioning mechanism, so that the distance between the magnet 20 and each Hall sensor 110 can be fixed.

Moreover, the keyswitch 10 may further include a restoring mechanism 100, which is configured to enable the keyswitch 10 to return form the pressed state to the non-pressed state after being pressed. Specifically, the restoring mechanism 100 is disposed on the circuit board 30, and the restoring mechanism 100 includes a casing 120, a plunger 130, and an elastic member 140. In this embodiment, one of the elastic member 140 and the plunger 130 can serve as the shielding member of the keyswitch 10.

The plunger 130 can be movably coupled with the casing 120. The plunger 130 is movable from a non-pressed position to a pressed position in response to the pressing force. The elastic member 140 is disposed in the casing 120 and moves along with the plunger 130. When the pressing force is released, the elastic member 140 provides the restoring force to enable the plunger 130 to return to the non-pressed position. Specifically, the casing 120 includes an upper casing 122 and a lower casing 124, which are combined with each other. The upper casing 122 has a through hole 1222 and an upper engaging portion 1224. The plunger 130 is movably inserted into the through hole 1222. The lower casing 124 has a lower engaging portion 1244, which is configured to engage with the upper engaging portion 1224, so that the upper casing 122 is combined with the lower casing 124. The lower casing 124 is preferably a base extending along the X-axis, Y-axis, and Z-axis directions, and the upper casing 122 is a cover corresponding to the lower casing 124. The lower casing 124 is combined with the upper casing 122 to form the casing 120 with an accommodation space for accommodating, for example, the elastic member 140. For example, the lower engaging portion 1244 of the lower casing 124 can be a hook-like portion, and the upper engaging portion 1224 of the upper casing 122 is a corresponding structure with a hole. As such, the lower casing 124 and the upper casing 122 can be combined along the Z-axis direction by engaging the hook-like portion with the hole. The through hole 1222 of the upper casing 122 preferably corresponds to the top portion of the plunger 130 in shape, so that the plunger 130 can be movably inserted into the through hole 1222 of the upper casing 122 from the lower side of the upper casing 122 with the top portion of the plunger 130 protruding from the through hole 1222. For example, the plunger 130 is preferably a hat-shaped column, which has a narrower top and a wider bottom. The plunger 130 may have a coupling portion 136. The coupling portion 136 is preferably disposed on the top portion of the plunger 130. The coupling portion 136 can be a cross-shaped protrusion formed on the top portion of the plunger 130 and is configured to couple with a keycap (not shown), but not limited thereto. In other embodiments, the coupling portion 136 can have other configurations (e.g. a coupling hole) to couple with the keycap.

In an embodiment, in the case that the elastic member 140 serves as the shielding member, the elastic member 140 can be a spring made of magnetically conductive material. For example, the magnetically conductive material preferably includes iron, cobalt, nickel, or an alloy thereof, such as Fe/Mn/Zn alloy, Fe/Ni/Zn alloy. In the case that the elastic member 140 is a spring made of the magnetically conductive material, the compression and recovery of the elastic member 140 can produce a change in configuration, thereby changing the shielding effect on the magnetic field and changing the magnetic field strength of the magnet 20 sensed by the Hall sensor 110. Specifically, the lower casing 124 has a positioning portion 1242, and the elastic member 140 can be positioned by the positioning portion 1242. For example, the positioning portion 1242 can be a ring-shaped wall extending from the bottom of the lower casing 124 toward the upper casing 122. One end of the spring (i.e., the elastic member 140) can be sleeved on the positioning portion 1242, and the other end of the spring is against the bottom of the plunger 130, and the top portion of the plunger 130 protrudes from the through hole 1222 of the upper casing 122. The Hall sensor 110 is preferably disposed in the ring-shaped wall of the positioning portion 1242. When the pressing force is applied, the plunger 130 moves downward and compresses the spring, so the spring has a compact configuration to enhance the shielding effect on the magnetic field of the magnet 20, and the magnetic field strength of the magnet 20 sensed by the Hall sensor is changed to trigger the keyswitch 10 to generate a trigger signal. When the pressing force is released, the spring provides the restoring force to enable the plunger 130 to move away from the lower casing 124 to the position before the pressing force is applied.

In another embodiment, in the case that the plunger 130 serves as the shielding member, the lower portion of the plunger 130 preferably includes the magnetically conductive material. For example, when the plunger 130 is formed by injection molding, the lower portion of the plunger 130 is doped with the magnetically conductive material (e.g. iron, cobalt, nickel, or an alloy thereof), so the plunger 130 can effectively shield the magnetic field by the lower portion. In another embodiment, the magnetically conductive material can be printed on the lower portion of the plunger 130. For example, the magnetically conductive material can be printed on the side of the plunger 130 that faces the magnet 20, but not limited thereto. Alternatively, the magnetically conductive material can be disposed on the periphery around the plunger 130, so the lower portion of the plunger 130 is magnetically conductive in all directions. With such a configuration, during assembly, there is no need to spend time aligning the magnetically conductive side of the plunger 130 with the magnet 20, effectively improving the convenience of assembly.

When the pressing force is applied, the plunger 130 moves downward, and the magnetically-conductive lower portion of the plunger 130 moves to the region between the magnet 20 and the Hall sensor 110 to at least partially shield the magnetic field of the magnet 20, so that the magnetic field strength of the magnet 20 which is sensed by the Hall sensor 110 can be changed, and the keyswitch 10 is triggered to generate the trigger signal. For example, when the pressing force is applied, the magnetically-conductive lower portion of the plunger 130 moves to cover the positioning portion 1242 of the lower casing 124 and thereby covering the Hall sensor 110 located in the ring-shaped wall of the positioning portion 1242 and effectively shielding the magnetic field of the magnet 20.

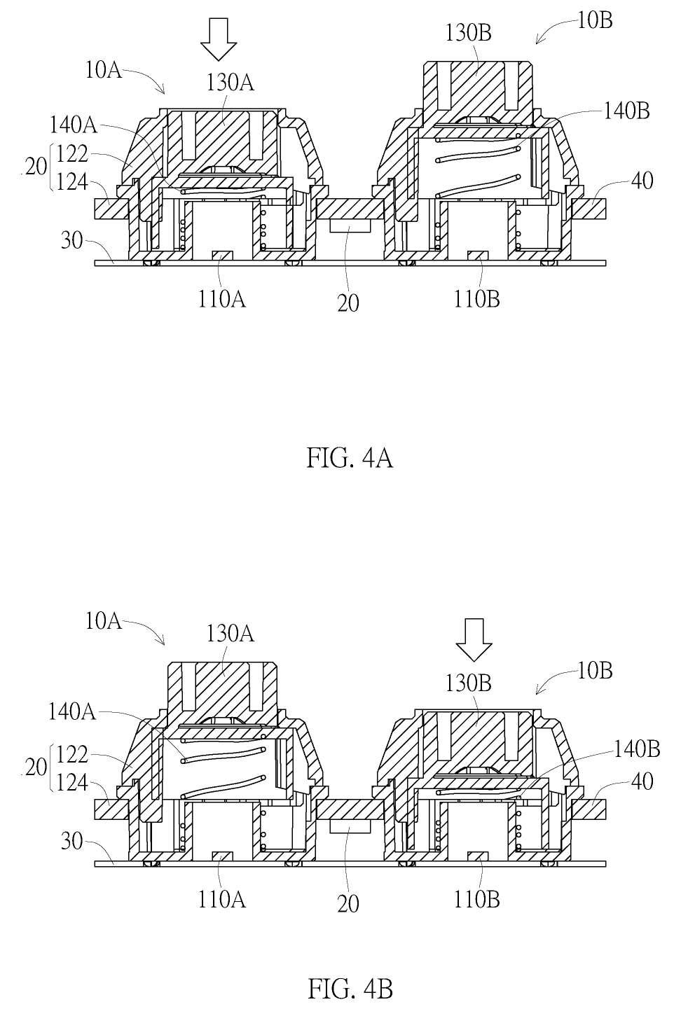

Referring to FIGS. 3 to 4B, FIG. 3 is a cross-sectional view of FIG. 2 along the A-A line; FIGS. 4A and 4B are operation views of adjacent keyswitches of FIG. 3. Hereinafter, the operation of adjacent keyswitches will be described in detail. The structural details of the keyswitches can be referred to the related descriptions of the above embodiments and will not be elaborated again. As shown in FIG. 3, the plurality of keyswitches 10 of the keyboard 1 includes a first keyswitch 10A and a second keyswitch 10B. The first keyswitch 10A includes a first shielding member (e.g. the plunger 130A or the elastic member 140A) and a first Hall sensor 110A. The second keyswitch 10B is disposed adjacent to the first keyswitch 10A, and the second keyswitch 10B includes a second shielding member (e.g. the plunger 130B or the elastic member 140B) and a second Hall sensor 110B. The magnet 20 is disposed between the first keyswitch 10A and the second keyswitch 10B. The magnet 20 is spaced apart from the first Hall sensor 110A by a first fixed distance, and the magnet 20 is spaced apart from the second Hall sensor 110B by a second fixed distance. In an embodiment, the first fixed distance is preferably substantially equal to the second fixed distance. The first shielding member and the second shielding member are preferably symmetrically disposed with respect to the magnet 20.

The circuit board 30 is disposed below the first keyswitch 10A and the second keyswitch 10B. The first Hall sensor 110A and the second Hall sensor 110B are electrically disposed on the circuit board 30. The positioning frame 40 is disposed above the circuit board 30. The first keyswitch 10A and the second keyswitch 10B are positioned by the positioning frame 40. In this embodiment, the magnet 20 is disposed on the lower surface of the positioning frame 40. Each of the first keyswitch 10A and the second keyswitch 10B further includes the restoring mechanism 100 described above.

As shown in FIG. 3, when the pressing force is not applied, such as the keyswitches 10A and 10B are not pressed, each of the first Hall sensor 110A and the second Hall sensor 110B senses the existence of the magnetic field of the magnet 20, wherein the magnetic field strength sensed by the first Hall sensor 110A and the magnetic field strength sensed by the second Hall sensor 110B are preferably the same, and each of the first Hall sensor 110A and the second Hall sensor 110B outputs a first voltage corresponding to the sensed magnetic field strength. For example, when the plunger 130A/130B is at the non-pressed position, the plunger 130A/130B is away from the region between the magnet 20 and the first Hall sensor 110A/the second Hall sensor 110B, and the elastic member 140A/140B has a loosen configuration, so the shielding member has smaller (or predetermined) influence or no influence on the magnetic field of the magnet 20, and the first Hall sensor 110A/the second Hall sensor 110B correspondingly outputs the first voltage.

As shown in FIG. 4A, when the first keyswitch 10A is pressed, the first shielding member (e.g. the plunger 130A or the elastic member 140A) moves relative to the magnet 20 and changes the magnetic field strength of the magnet 20 sensed by the first Hall sensor 110A. For example, when the first keyswitch 10A is pressed, the plunger 130A moves toward the circuit board 30 to a position capable of influencing the magnetic field of the magnet 20 and compresses the elastic member 140A, so that the elastic member 140A has a compact configuration to enhance the shielding effect on the magnetic field of the magnet 20, and the first Hall sensor 110A senses the changed magnetic field strength and outputs a second voltage. In this embodiment, since the first shielding member is preferably made of magnetically conductive material to provide the shielding effect between the magnet 20 and the first Hall sensor 110A, the second voltage outputted by the first Hall sensor 110A is smaller than the first voltage. The first keyswitch 10A can generate the trigger signal based on the change of voltage outputted by the first Hall sensor 110A. From another aspect, when the shielding member moves downward closer to the first Hall sensor 110A, the shielding effect is enhanced, so the voltage outputted by the first Hall sensor 110A becomes smaller as the distance that the shielding member moves downward longer. As such, the first keyswitch 10A can set the trigger point based on the difference between the second voltage and the first voltage outputted by the first Hall sensor 110A. For example, the larger the value of difference is, the longer the moving distance of the shielding member is, so the later the trigger is. As such, the advantage of adjusting the trigger point according to practical applications can be achieved. At the same time, since the second keyswitch 10B is not pressed, the shielding effect of the second shielding member on the magnetic field remains unchanged, so the magnetic field strength sensed by the second Hall sensor 110B remains the same, and the first voltage is outputted by the second Hall sensor 110B.

As shown in FIG. 4B, when the second keyswitch 10B is pressed, the second shielding member (e.g. the plunger 130B or the elastic member 140B) moves relative to the magnet 20 and changes the magnetic field strength of the magnet 20 sensed by the second Hall sensor 110B. At the same time, the first keyswitch 10A is not pressed, so the first Hall sensor 110A remains outputting the first voltage. It is noted that the operation of the second keyswitch 10B when being pressed is similar to that of the first keyswitch 10A, so the detailed pressing operation of the second keyswitch 10B can refer to that of the first keyswitch 10A described above and will not be elaborated again.

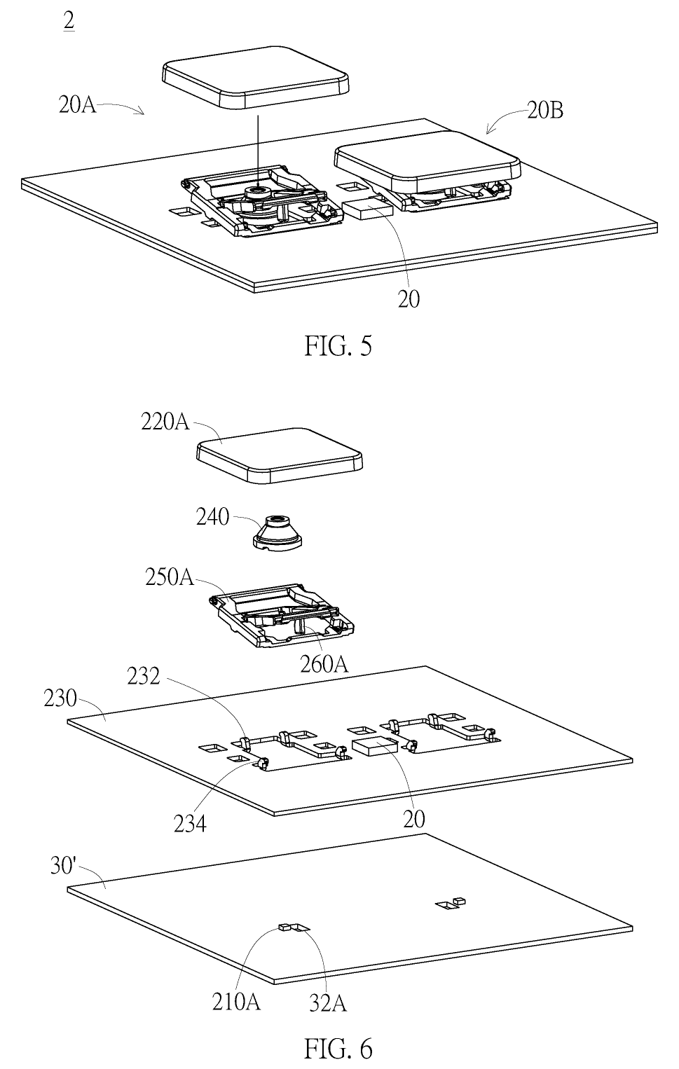

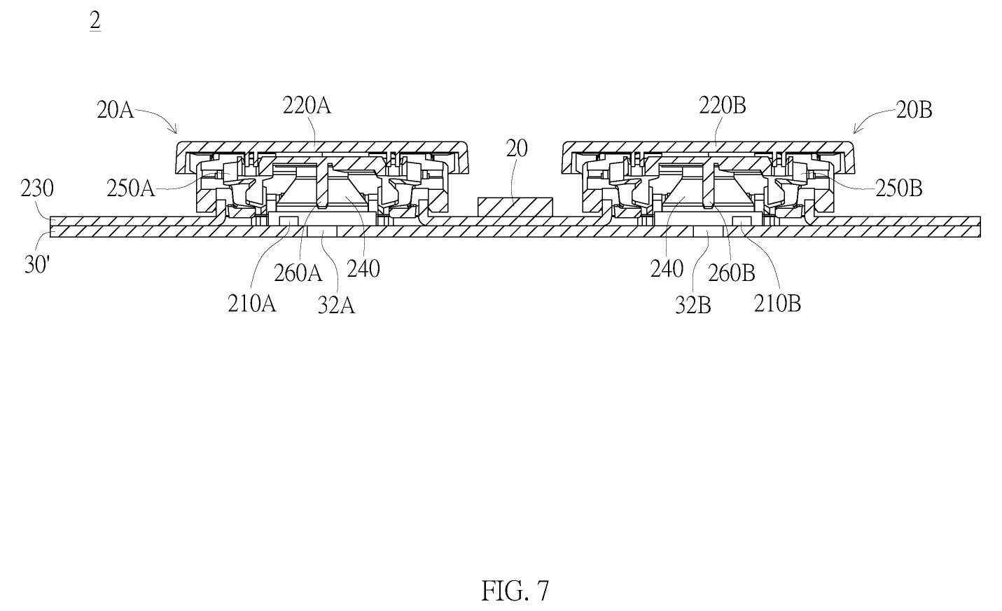

The shielding member can be disposed on any suitable moveable member of the keyswitch, not limited to the above embodiments. Referring to FIGS. 5 to 7, FIG. 5 is a three-dimensional view of the keyboard 2 in a second embodiment of the invention; FIG. 6 is an exploded view of the keyswitch structure (e.g. 20A/20B) of the keyboard 2 of FIG. 5; FIG. 7 is a cross-sectional view of the keyboard 2 of FIG. 5. As shown in FIGS. 5 to 7, in this embodiment, the keyboard 2 includes a first keyswitch 20A, a second keyswitch 20B, and a magnet 20. The first keyswitch 20A includes a first shielding member 260A and a first Hall sensor 210A. The second keyswitch 20B is disposed adjacent to the first keyswitch 20A and includes a second shielding member 260B and a second Hall sensor 210B. The magnet 20 is disposed between the first keyswitch 20A and the second keyswitch 20B. The magnet 20 is spaced apart from the first Hall sensor 210A by a first fixed distance, and the magnet 20 is spaced apart from the second Hall sensor 210B by a second fixed distance. The first Hall sensor 210A and the second Hall sensor 210B are disposed on the circuit board 30’ and electrically connected to the switch circuit of the circuit board 30’.

In the second embodiment, the first keyswitch 20A further includes a first keycap 220A and a first support mechanism 250A. The first support mechanism 250A is disposed under the first keycap 220A and supports the first keycap 220A to move relative to the circuit board 30’. The first shielding member 260A is disposed on the first support mechanism 250A. The first support mechanism 250A drives the first shielding member 260A to move relative to the magnet 20. The second keyswitch 20B further includes a second keycap 220B and a second support mechanism 250B. The second support mechanism 250B is disposed under the second keycap 220B and supports the second keycap 220B to move relative to the circuit board 30’. The second shielding member 260B is disposed on the second support mechanism 250B, and the second support mechanism 250B drives the second shielding member 260B to move relative to the magnet 20.

The keyboard 2 may further include a baseplate 230, which is configured to enhance the structural strength of the keyswitch. The baseplate 230 can be disposed above or below the circuit board 30’ (e.g. above the circuit board 30’ in this embodiment), and the first support mechanism 250A is movably connected to the baseplate 230 and the first keycap 220A, but not limited thereto. When the circuit board 30’ can provide sufficient support strength, the keyboard 2 may not need the baseplate 230, and the first support mechanism 250A is movably connected to the circuit board 30’ and the first keycap 220A.

Specifically, the first support mechanism 250A includes a scissors-like support mechanism, which includes an inner frame and an outer frame pivotally connected to each other. Two opposite ends of each of the inner frame and the outer frame can be respectively movably coupled with the first keycap 220A and the baseplate 230, so the first support mechanism 250A stably supports the first keycap 220A to move relative to the baseplate 230. The baseplate 230 has a plurality of coupling members 232 and 234, which are respectively coupled with the baseplate ends of the inner frame and the outer frame of the first support mechanism 250A. The first keycap 220A may have corresponding connecting members (not shown), which are respectively coupled with the keycap ends of the inner frame and the outer frame of the first support mechanism 250A. With such a configuration, the first support mechanism 250A can stably support the first keycap 220A to move upward/downward relative to the baseplate 230 (or the circuit board 30’). The second support mechanism 250B may have the same structure as the first support mechanism 250A. Accordingly, the structural details of the second support mechanism 250B can be referred to the related descriptions of the first support mechanism 250A. Moreover, the baseplate 230 has a plurality of coupling members 232 and 234, which can be respectively coupled with the baseplate ends of the inner frame and the outer frame of the second support mechanism 250B.

In this embodiment, the first shielding member 260A is disposed at the inner side of the inner frame of the first support mechanism 250A. The first shielding member 260A can be a protrusion, which extends downward from the inner frame and is preferably located on the inner side of the keycap end of the inner frame. Similar to the above embodiments, the first shielding member 260A is preferably made of a material that can influence the magnetic field between the magnet 20 and the first Hall sensor 210A. As such, the movement of the first shielding member 260A relative to the magnet 20 and the first Hall sensor 210A will cause the first Hall sensor 210A to output different voltages. The first shielding member 260A preferably includes a material, such as iron, cobalt, nickel, or an alloy thereof (e.g. Fe/Mn/Zn alloy, Fe/Ni/Zn alloy), and can be attached to the first support mechanism 250A by any suitable manner, such as adhering, engaging, screwing. Alternatively, when the inner frame is formed by injection-molding, a corresponding portion (e.g. protrusion portion) of the inner frame can be doped with magnetically conductive materials, so the first shielding member 260A is integrally formed with the inner frame of the first support mechanism 250A, and the first shielding member 260A is made of a composite material including plastics and magnetic conductors.

Similarly, the second shielding member 260B is disposed at the inner side of the inner frame of the second support mechanism 250B. The second shielding member 260B can be a protrusion, which extends downward from the inner frame and is preferably located on the inner side of the keycap end of the inner frame. The second shielding member 260B includes a magnetically conductive material. For example, the magnetically conductive material includes iron, cobalt, nickel, or an alloy thereof. The detailed structure and function of the second shielding member 260B are similar to those of the first shielding member 260A and can be referred to the related descriptions of the first shielding member 260A, which will not be elaborated again. The first shielding member 260A and the second shielding member 260B are preferably symmetrically disposed with respect to the magnet 20. In an embodiment, the magnet 20 is preferably located outside vertical projections of the first keycap 220A and the second keycap 220B. In other words, the magnet 20 is preferably located at the gap between adjacent keyswitches of the keyboard 2. In an embodiment, the magnet 20 is preferably disposed on the baseplate 230, but not limited thereto. According to practical applications, the magnet 20 can be disposed on the circuit board 30’.

Corresponding to the first shielding member 260A and the second shielding member 260B, the circuit board 30’ may include a first opening 32A and a second opening 32B. The first opening 32A and the second opening 32B are respectively disposed corresponding to the first shielding member 260A and the second shielding member 260B and allow the first shielding member 260A to at least partially extend into the first opening 32A when the first keycap 220A is pressed, and allow the second shielding member 260B to at least partially extend into the second opening 32B when the second keycap 220B is pressed. The magnet 20 and the first Hall sensor 210A are respectively disposed at two opposite sides with respect to the first opening 32A. The magnet 20 and the second Hall sensor 210B are respectively disposed at two opposite sides with respect to the second opening 32B. For example, the first shielding member 260A and the second shielding member 260B are preferably symmetrically disposed with respect to the magnet 20, and the first opening 32A and the second opening 32B are symmetrically disposed with respect to the magnet 20.

Each of the first keyswitch 20A and the second keyswitch 20B may further include a restoring mechanism 240, which is configured to enable the first keyswitch 20A or the second keyswitch 20B to return from the pressed state to the non-pressed state after being pressed. In this embodiment, the restoring mechanism 240 can be implemented as a rubber dome, but not limited thereto. According to practical applications, the restoring mechanism 240 can be replaced with the restoring mechanism 100 of FIG. 1, which includes the casing, the plunger, and the elastic member (spring) to provide the restoring force to enable the first keycap 220A or the second keycap 220B to return the non-pressed state.

Referring to FIG. 7, 8A and 8B, the operation of adjacent keyswitches (e.g. 20A/20B) of the keyboard 2 of the second embodiment will be described. As shown in FIG. 7, when no pressing force is applied, such as none of the first keycap 220A and the second keycap 220B is pressed, each of the first Hall sensor 210A and the second Hall sensor 210B senses the existence of the magnetic field of the magnet 20 and outputs the first voltage corresponding to the sensed magnetic field strength. For example, the first shielding member 260A/the second shielding member 260B is located at the non-pressed position away from the region between the magnet 20 and the first Hall sensor 210A/the second Hall sensor 210B. In such a configuration, the shielding member has smaller (or predetermined) influence or no influence on the magnetic field of the magnet 20, and the first Hall sensor 210A/the second Hall sensor 210B correspondingly outputs the first voltage.

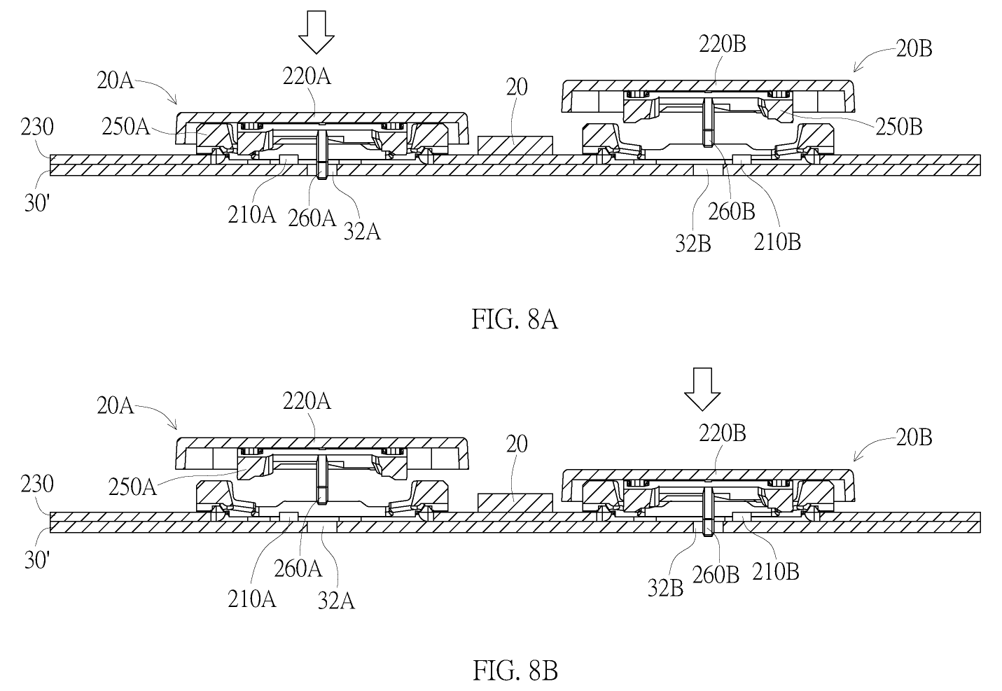

As shown in FIG. 8A, when the pressing force is applied, such as the first keycap 220A is pressed, the first keycap 220A moves downward and compresses the restoring mechanism 240, and the first support mechanism 250A moves with the first keycap 220A to drive the first shielding member 260A to move toward between the magnet 20 and the first Hall sensor 210A, and the first Hall sensor 210A outputs the second voltage. In other words, the first shielding member 260A moves downward toward the first Hall sensor 210A and the magnet 20 to a position that the magnetic field of the magnet 20 is affected. For example, the first shielding member 260A is at least partially located on or in the neighborhood of the virtual line of the magnet 20 and the first Hall sensor 210A. As such, the first Hall sensor 210A senses the changed magnetic field and correspondingly outputs the second voltage, which is smaller than the first voltage, and the first keyswitch 20A is triggered to generate the trigger signal. When the first shielding member 260A moves downward toward the first Hall sensor 210A, the first shielding member 260A can at least partially extend into the first opening 32A of the circuit board 30’. At the same time, the second keyswitch 20B is not pressed, so the second Hall sensor 210B remains outputting the first voltage.

As shown in FIG. 8B, when the second keyswitch 20B is pressed, the second shielding member 260B moves relative to the magnet 20 and changes the magnetic field strength of the magnet 20 sensed by the second Hall sensor 210B. At the same time, the first keyswitch 20A is not pressed, so the first Hall sensor 110A remains outputting the first voltage. It is noted that the operation of the second keyswitch 20B when being pressed is similar to that of the first keyswitch 20A, so the detailed operation of the second keyswitch 20B can be referred to that of the first keyswitch 20A described above and will not be elaborated again.

From the embodiments of FIGS. 1 to 3, the invention also provides a keyswitch structure (e.g. the keyswitch 10), which may include a keycap (not shown), an elastic member 140, a Hall sensor 110, and a magnet 20. The elastic member 140 is disposed under the keycap and provides a restoring force. The Hall sensor 110 is disposed below the elastic member 140. The magnet 20 is disposed corresponding to the Hall sensor 110. When the keycap is pressed, the magnet 20 and the Hall sensor 110 are spaced apart by a fixed distance, and the elastic member 140 moves relative to the magnet 20 to change the magnetic field strength of the magnet 20 sensed by the Hall sensor 110. The elastic member 140 can be embodied as a spring made of magnetically conductive material. The compression and recovery of the elastic member 140 can produce a change in configuration, thereby changing the shielding effect on the magnetic field and changing the magnetic field strength of the magnet 20 sensed by the Hall sensor 110. Therefore, there is no need to customed design the shielding member, improving the compatibility for different keyswitch structures.

Moreover, in the second embodiment of FIGS. 5 to 7, the shielding member is disposed on the support mechanism and moves with the support mechanism, but not limited thereto. In other embodiments (not shown), the shielding member can be integrated with the elastic member in the shape of a rubber dome (e.g. the restoring mechanism 240), so the shielding member can change the magnetic field strength sensed by the Hall sensor in response to the deformation of collapse of the elastic member. For example, the column extending downward from the inner side of the rubber dome can be printed, coated, or doped with magnetically conductive material, so the column is magnetically conductive and capable of shielding the magnetic field as the shielding member. When the pressing force is applied, the keycap presses the rubber dome downward, and the column of the rubber dome moves downward toward between the Hall sensor and the magnet in response to the deformation of collapse of the rubber dome, so that the magnetic field strength of the magnet sensed by the Hall sensor can be changed.

Although the preferred embodiments of the invention have been described herein, the above description is merely illustrative. The preferred embodiments disclosed will not limit the scope of the invention. Further modification of the invention herein disclosed will occur to those skilled in the respective arts and all such modifications are deemed to be within the scope of the invention as defined by the appended claims.

What is claimed is:

1. A keyboard, comprising:
a first keyswitch comprising a first shielding member and a first Hall sensor;
a second keyswitch disposed adjacent to the first keyswitch, the second keyswitch comprising a second shielding member and the second Hall sensor; and
a magnet disposed between the first keyswitch and the second keyswitch, the magnet spaced apart from the first Hall sensor by a first fixed distance and spaced apart from the second Hall sensor by a second fixed distance,
wherein when the first keyswitch is pressed, the first shielding member moves relative the magnet and changes a magnetic field strength of the magnet sensed by the first Hall sensor; when the second keyswitch is pressed, the second shielding member moves relative to the magnet and changes a magnetic field strength of the magnet sensed by the second Hall sensor.

2. The keyboard of claim 1, wherein the first fixed distance is substantially equal to the second fixed distance.

3. The keyboard of claim 1, further comprising a circuit board, wherein the circuit board is disposed below the first keyswitch and the second keyswitch; the first Hall sensor and the second Hall sensor are electrically disposed on the circuit board.

4. The keyboard of claim 3, further comprising a positioning frame, wherein the positioning frame is disposed above the circuit board; the first keyswitch and the second keyswitch are positioned by the positioning frame; the magnet is disposed on the positioning frame or the circuit board.

5. The keyboard of claim 3, wherein each of the first keyswitch and the second keyswitch further comprises a restoring mechanism disposed on the circuit board; the restoring mechanism comprises:
a casing;
a plunger movably coupled with the casing; and
an elastic member disposed in the casing and moving along with the plunger,
wherein one of the elastic member and the plunger serves as the first shielding member or the second shielding member.

6. The keyboard of claim 3, wherein the circuit board has a first opening and a second opening; the first opening and the second opening are respectively disposed corresponding to the first shielding member and the second shielding member and allow the first shielding member to at least partially extend into the first opening when the first keyswitch is pressed and the second shielding member to at least partially extend into the second opening when the second keyswitch is pressed.

7. The keyboard of claim 3, wherein the first keyswitch comprises a first keycap and a first support mechanism; the first support mechanism is disposed under the first keycap and supports the first keycap to move relative to the circuit board; the first shielding member is disposed on the first support mechanism; the first support mechanism drives the first shielding member to move relative to the magnet.

8. The keyboard of claim 7, wherein the second keyswitch comprises a second keycap and a second support mechanism; the second support mechanism is disposed under the second keycap and supports the second keycap to move relative to the circuit board; the second shielding member is disposed on the second support mechanism; the second support mechanism drives the second shielding member to move relative to the magnet.

9. The keyboard of claim 1, wherein the first keyswitch comprises a first keycap; the second keyswitch comprises a second keycap; the magnet is located outside vertical projections of the first keycap and the second keycap.

10. The keyboard of claim 1, wherein the first shielding member and the second shielding member are symmetrically disposed with respect to the magnet.

11. The keyboard of claim 1, wherein each of the first shielding member and the second shielding member comprises a magnetically conductive material; the magnetically conductive material comprises iron, cobalt, nickel, or an alloy thereof.

12. A keyswitch structure, comprising:
a keycap;
an elastic member disposed under the keycap to provide a restoring force;
a Hall sensor disposed below the elastic member; and
a magnet disposed corresponding to the Hall sensor,
wherein when the keycap is pressed, the magnet and the Hall sensor are spaced apart by a fixed distance, and the elastic member moves relative to the magnet to change a magnetic field strength of the magnet sensed by the Hall sensor.

13. The keyswitch structure of claim 12, wherein the elastic member comprises a magnetically conductive material; the magnetically conductive material comprises iron, cobalt, nickel, or an alloy thereof.
